(19) United States
(12) Patent Application Publication
(10) Pub. No.: US 2005/0127324 A1
(43) Pub. Date: Jun. 16, 2005

(54) Gas generating composition

(76) Inventor: Jianzhou Wu, Hyogo (JP)

Correspondence Address: BIRCH STEWART KOLASCH & BIRCH, PO BOX 747, FALLS CHURCH, VA, 22040-0747, US

(21) Appl. No.: 10/968,892

(22) Filed: Oct. 21, 2004

Related U.S. Application Data
(60) Provisional application No. 60/514,557, filed on Oct. 27, 2003.

(30) Foreign Application Priority Data
Oct. 22, 2003 (JP) 2003-361979

(51) Int. Cl. C01B 21/00

(52) U.S. Cl. 252/181.3

(57) ABSTRACT

A gas generating composition, in which a combustion temperature is low and the generation amounts of carbon monoxide, ammonia, and nitrogen oxide after combustion is suppressed, comprises the following components (a) to (c) and, based on necessity, further comprises the components selected from the following components (d) to (f): (a) an organic compound as fuel, (b) an oxygen-containing oxidizing agent, (c) magnesium hydroxide or a mixture of magnesium hydroxide and aluminum hydroxide, (d) a binder, (e) an additive selected from metal oxides and metal carbonates, and
(f) silicon dioxide having a specific surface area of 100 to 500 m²/g.

### TECHNICAL FIELD OF THE INVENTION

The invention relates to a gas generating composition suitable for an air bag restraining system of automobiles and the like, a molded article thereof and an inflator for an air bag using the same.

### PRIOR ARTS

As a gas generating agent for an air bag as passenger-protecting system in automobiles, a composition using sodium azide has conventionally been used. However, a toxicity to human bodies [LD₅₀ (oral-rat=27 mg/kg)] or hazard in handling of sodium azide has been regarded as a serious problem. Therefore, as safe non-azide-based gas generating compositions substituting for the above, gas generating compositions including various nitrogen-containing organic compounds have been developed.

U.S. Pat. No. 4,909,549 discloses a composition comprising hydrogen-containing tetrazole or triazole compounds and an oxygen-containing oxidizing agent. U.S. Pat. No. 4,370,181 discloses a gas generating composition comprising a hydrogen-free bitetrazole metal salt and an oxygen-free oxidizing agent. U.S. Pat. No. 4,369,079 discloses a gas generating composition comprising a hydrogen-free bitetrazole metal salt and an alkali metal nitrate, an alkaline metal nitrite, an alkaline earth metal nitrate, an alkaline earth metal nitrite, or a mixture thereof. U.S. Pat. No. 5,542,999 discloses a gas generating agent comprising a fuel such as GZT, TAGN (triaminonitroguanidine), NG (nitroguanidine), NTO, and the like, a basic copper nitrate, a catalyst for reducing toxic gases, and a coolant agent. JP-A No. 10-72273 discloses a gas generating agent comprising a bitetrazole metal salt, a bitetrazole ammonium salt, aminotetrazole, and ammonium nitrate.

However, an azide-based gas generating agent generally produces only nitrogen after combustion. On the other hand, the non-azide-based gas generating composition generally comprises carbon, nitrogen, and oxygen, and therefore, has such a drawback that a small amount of toxic carbon monoxide and nitrogen oxide is produced after combustion. Also, in general, the non-azide-based gas generating agent has a high combustion temperature as compared with that of an azide-based gas generating agent, and a large quantity of a coolant is necessary in actual use.

In order to decrease the production amounts of the toxic carbon monoxide and nitrogen oxide after combustion, it is known that a metal oxide or a DeNOx agent (a nitrogen oxide decreasing agent) is added to the gas generating agent. For example, the gas generating composition disclosed in DE-B No. 4,401,213 comprises a heavy metal oxide such as V₂O₅/MoO₃ as a catalyst to suppress the toxic carbon monoxide and nitrogen oxide. However, a heavy metal oxide itself is toxic, and if a metal oxide is added, the gas output of the gas generating agent is lowered.

WO-A No. 98/04507 discloses that the production amount of nitrogen oxide in the combustion gas is decreased by using DeNOx agent such as ammonium sulfate, ammonium carbonate or a urea, in combination with a gas generating agent. However, if ammonium sulfate is used, toxic sulfur oxide is produced and ammonium carbonate and urea are problematic in thermal stability and further, if the DeNOx agent thereof is added, the oxidizing agent of the gas generating agent is consumed and the production amount of toxic carbon monoxide is increased.

### DISCLOSURE OF THE INVENTION

Accordingly, a purpose of the invention is to provide a gas generating composition which suppresses generation of toxic carbon monoxide and nitrogen oxide and has a low combustion temperature, a molded article thereof and an inflator for an air bag using the above.

The inventors of the invention have found that the combustion temperature can be lowered by selecting a specified combination for a gas generating composition and as a result, the generation amounts of toxic carbon monoxide, ammonium, and nitrogen oxide can be decreased in a combustion gas, thereby having accomplished the invention.

As means for solving the above-mentioned problems, the invention provides a gas generating composition comprising the following components (a), (b) and (c), and based on necessity, further comprising one, two, or three components selected from the following components (d), (e), and (f):
(a) an organic compound as fuel,
(b) an oxygen-containing oxidizing agent,
(c) magnesium hydroxide or a mixture of magnesium hydroxide and aluminum hydroxide,
(d) a binder,
(e) an additive selected from metal oxides and metal carbonates, and
(f) silicon dioxide having a specific surface area of 100 to 500 m²/g.

Further, the present invention provides, as another solving means for the above problem, a molded article of the gas generating composition obtained by molding the gas generating composition, and an inflator for an air bag using the gas generating composition or the molded article of the gas generating composition.

The gas generating composition and its molded article of the invention have low combustion temperatures and suppress the generation amounts of carbon monoxide and nitrogen oxide at the time of combustion.

### PREFERRED EMBODIMENT OF THE INVENTION

The organic compound as fuel of the component (a) to be used in the invention may be at least one compound selected from tetrazole compounds, guanidizne compounds, triazine compounds, and nitroamine compounds.

As the tetrazole compounds, 5-aminotetrazole, bitetrazole ammonium salt and the like are preferable. As the guanidines, nitric acid guanidine salt (nitric acid guanidine), aminoguanidine nitric acid salt, nitroguanidine, triaminoguanidine nitric acid salt and the like are preferable. As triazine compounds, melamine, cyanuric acid, ammeline, ammelide, ammeland and the like are preferable. As nitroamine compounds, cyclo-1,3,5-trimethine-2,4,6-trinitramine is preferable.

The oxygen-containing oxidizing agent of the component (b) preferably comprises at least one selected from the group consisting of (b-1) basic metal nitric acid salt, nitric acid salt, and ammonium nitrate and (b-2) perchloric acid salt and chloric acid salt.

An example of the basic metal nitric acid salt of the component (b-1) can be at least one selected from the group consisting of basic copper nitrate, basic cobalt nitrate, basic zinc nitrate, basic manganese nitrate, basic iron nitrate, basic molybdenum nitrate, basic bismuth nitrate, and basic cerium nitrate.

In order to increase a burning rate, the basic metal nitrate is preferable to have the average particle diameter of 30 μm or smaller, more preferably 10 μm or smaller. The average particle diameter is measured according to a particle size distribution method using a laser scattered beam. The measurement sample is prepared by dispersing the basic metal nitrate in water and radiating an ultrasonic wave for 3 minutes and 50% cumulative values (D₅₀) of the number of particles are calculated, and the average of the values measured twice is employed as the average particle diameter.

An example of the nitric acid salt of the component (b-1) can be alkali metal nitrates such as potassium nitrate, sodium nitrate or the like and alkaline earth metal nitrates such as strontium nitrate or the like.

The perchloric acid salt and the chloric acid of the component (b-2) are components having the oxidizing function and combustion promoting function. The oxidizing function means to generate oxygen during the combustion and accordingly to efficiently promote combustion as well as to suppress the production amount of the toxic gases such as ammonia, carbon monoxide and the like. Meanwhile, the combustion promoting function means to improve the ignition property of the gas generating composition or to improve the burning rate of the composition.

An example of the perchloric acid salts and chloric acid salts can be at least one selected from the group consisting of ammonium perchlorate, potassium perchlorate, sodium perchlorate, potassium chlorate and sodium chlorate.

The component (c) to be used in the invention is magnesium hydroxide or a mixture of magnesium hydroxide and aluminum hydroxide, and it is preferable to use magnesium hydroxide alone. In the case of using a mixture of magnesium hydroxide and aluminum hydroxide, the content of magnesium hydroxide is 50% by mass or higher.

Magnesium hydroxide and aluminum hydroxide are used as a flame retardant required to be scarcely toxic, material for artificial marble and additives to a detergent, a resin or rubber. They are characterized in that they have a low toxicity and a high decomposition starting temperature. Further, they greatly absorb heat when they are thermally decomposed and produce magnesium oxide or aluminum oxide with water. Therefore, adding magnesium hydroxide and aluminum hydroxide is effective to lower the combustion temperature of the gas generating composition and suppress the toxic nitrogen oxide and carbon monoxide at the time of combustion. Such toxic gas decreasing function becomes remarkable when the (b-2) component is used as the oxidizing agent.

By adjusting the average particle diameter, magnesium hydroxide or aluminum hydroxide can improve the entire dispersibility when the components (a) to (c) are mixed, so that the mixing work is made easy and the ignition property of the obtained gas generating composition can be improved as well.

The average particle diameter of magnesium hydroxide or aluminum hydroxide is preferably 0.1 to 70 μm, more preferably 0.5 to 50 μm, and still more preferably 2 to 30 μm. The measurement method of the average particle diameter is the same measurement method of the average particle diameter of the basic metal nitric acid salt.

The binder of the component (d) to be used in the invention is a component to be used together with, based on the necessity, the components (a) to (c), or together with the components (a) to (c) as well as the component (e) and/or the component (f), and the binder is a component to improve the formability of the gas generating composition and increase the strength of a molded article of the gas generating agent. If the strength of the molded article of the gas generating agent molded article is insufficient, it may occur that the molded article breaks at the time of actual combustion and is burned too intensively to control the combustion.

An example of the binder may be at least one selected from the group consisting of carboxymethyl cellulose, carboxymethyl cellulose sodium salt, carboxymethyl cellulose potassium salt, carboxymethyl cellulose ammonium salt, cellulose acetate, cellulose acetate butyrate, methyl cellulose, ethyl cellulose, hydroxyethyl cellulose, ethyl hydroxyethyl cellulose, hydroxypropyl cellulose, carboxymethyl ethyl cellulose, microcrystalline cellulose, polyacrylamide, amino compounds of polyacrylamide, polyacrylhydrazine, acrylamide-metal acrylate copolymer, polyacrylamide-poly(acrylic acid ester) copolymer, polyvinylalcohol, acrylicrubber, guargum, starch, and silicone.

The additive selected from metal oxides and metal carbonates as the component (e) to be used in the invention is a component to be used, based on the necessity, together with the components (a) to (c), or together with the components (a) to (c) as well as the component (e) and/or the component (f), and the additive is a component to assist the function of aluminum hydroxide, that is, to lower the combustion temperature of the gas generating agent, adjust the burning rate, and suppress the production amounts of toxic nitrogen oxide and carbon monoxide after combustion.

An example of the additive can be at least one selected from the group consisting of metal oxides such as copper oxide, iron oxide, zinc oxide, cobalt oxide, manganese oxide, molybdenum oxide, nickel oxide, bismuth oxide, silica and alumina; metal carbonates and basic metal carbonates such as cobalt carbonate, calcium carbonate, basic zinc carbonate and basic copper carbonate; complex compounds of metal oxides and hydroxides such as Japanese acid clay, kaolin, talc, bentonite, diatomaceous earth and hydrotalcite; metal acid salts such as sodium silicate, mica molybdenic acid salt, cobalt molybdate and ammonium molybdate; molybdenum disulfide, calcium stearate, silicon nitride and silicon carbide.

Silicon dioxide of the component (f) to be used in the invention is a component to be used, based on the necessity, together with the components (a) to (c), or together with the components (a) to (c) as well as the component (d) and/or the component (e) and silicon dioxide is a component added to improve the ignition property of the component (a). The effect of improving the ignition property of the component (a) is particularly remarkable when guanidine compounds are used as the component (a).

Silicon dioxide of the component (f) has a specific surface area of preferably 100 to 500 m²/g and more preferably 150 to 300 m²/g. The specific surface area is measured by BET method.

The contents and mixing examples of the respective components included in the gas generating composition of the invention are as follows.

(1) Composition of the Components (a) to (c)

The content of the organic compound of the component (a) is preferably 10 to 60% by mass, more preferably 15 to 60% by mass and still more preferably 10 to 55% by mass.

The content of the oxidizing agent of the component (b-1) is preferably 10 to 85% by mass, more preferably 20 to 70% by mass and still more preferably 30 to 60% by mass.

The content of the oxidizing agent of the component (b-2) is preferably 0.5 to 20% by mass, more preferably 1 to 10% by mass and still more preferably 1 to 5% by mass.

The content of magnesium hydroxide (or a mixture of magnesium hydroxide and aluminum hydroxide) of the component (c) is preferably 0.1 to 20% by mass, more preferably 3 to 15% by mass and still more preferably 4 to 10% by mass.

(Mixing Example 1)

(a) nitric acid guanidine 30 to 60% by mass,
(b) basic copper nitrate 30 to 60% by mass, and
(c) magnesium hydroxide 3 to 10% by mass.
   (Mixing Example 2)
(a) nitroguanidine 25 to 60% by mass,
(b) basic copper nitrate 30 to 60% by mass, and
(c) magnesium hydroxide 3 to 15% by mass.
   (Mixing Example 3)
(a) nitric acid guanidine or melamine 15 to 50% by mass,
(b-1) basic copper nitrate 30 to 70% by mass,
(b-2) at least one perchloric acid salt selected from the group consisting of sodium perchlorate, potassium perchlorate and ammonium perchlorate 0.5 to 5% by mass, and
(c) magnesium hydroxide 0.5 to 10% by mass.
   (Mixing Example 4)
(a) nitric acid guanidine or melamine 15 to 50% by mass,
(b-1) basic copper nitrate 30 to 70% by mass,
(b-2) sodium chlorate or potassium chlorate 0.5 to 5% by mass, and
(c) magnesium hydroxide 0.5 to 10% by mass.

(3) Composition comprising one, two, or three components selected from the component (d), the component (e), and the component (f) in addition to the components (a) to (c).
(d) The content of the component (d) is preferably 20% by mass or less, more preferably 0.5 to 10% by mass, and still more preferably 1 to 7% by mass.
(e) The content of the component (e) is preferably 20% by mass or less, more preferably 1 to 15% by mass, and still more preferably 3 to 10% by mass.
   (Mixing Example 5)
(a) nitroguanidine 20 to 50% by mass,
(b) basic copper nitrate 30 to 60% by mass,
(c) magnesium hydroxide 0.5 to 15% by mass, and
(d) carboxymethyl cellulose sodium salt or guar gum 0.5 to 10% by mass.
   (Mixing Example 6)
(a) nitroguanidine 30 to 50% by mass,
(b) basic copper nitrate 30 to 60% by mass,
(c) magnesium hydroxide 0.5 to 10% by mass, and
(d) guar gum 0.5 to 10% by mass.
   (Mixing Example 7)
(a) melamine 15 to 40% by mass,
(b) basic copper nitrate 30 to 70% by mass,
(c) magnesium hydroxide 0.5 to 15% by mass, and
(d) carboxymethyl cellulose sodium salt or guar gum 0.5 to 10% by mass.
   (Mixing Example 8)
(a) nitric acid guanidine 30 to 50% by mass,
(b) basic copper nitrate 30 to 60% by mass,
(c) magnesium hydroxide 0.5 to 15% by mass, and
(d) carboxymethyl cellulose sodium salt or guar gum 0.5 to 10% by mass.
   (Mixing Example 9)
(a) two or three components selected from the group consisting of nitric acid guanidine, nitroguanidine and melamine 15 to 50% by mass,
(b) basic copper nitrate 30 to 60% by mass,
(c) magnesium hydroxide 0.5 to 15% by mass, and
(d) carboxymethyl cellulose sodium salt or guar gum 0.5 to 10% by mass.
   (Mixing Example 10)
(a) nitric acid guanidine or melamine 15 to 50% by mass,
(b-1) basic copper nitrate 30 to 60% by mass,
(b-2) at least one perchloric acid salt selected from the group consisting of sodium perchlorate, potassium perchlorate and ammonium perchlorate 0.5 to 5% by mass,
(c) magnesium hydroxide 0.5 to 15% by mass, and
(d) carboxymethyl cellulose sodium salt or guar gum 0.5 to 10% by mass.
   (Mixing Example 11)
(a) nitric acid guanidine or melamine 15 to 50% by mass,
(b-1) basic copper nitrate 30 to 60% by mass,
(b-2) sodium chlorate or potassium chlorate 0.5 to 5% by mass,
(c) magnesium hydroxide 0.5 to 15% by mass, and
(d) carboxymethyl cellulose sodium salt or guar gum 0.5 to 10% by mass.
   (Mixing Example 12)
(a) nitric acid guanidine 30 to 50% by mass,
(b) basic copper nitrate 30 to 60% by mass,
(c) magnesium hydroxide 0.5 to 15% by mass, and
(f) silicon dioxide 0.1 to 5% by mass.
   (Mixing Example 13)
(a) nitric acid guanidine 30 to 50% by mass,
(b) basic copper nitrate 30 to 60% by mass,
(c) magnesium hydroxide 0.5 to 15% by mass,
(d) carboxymethyl cellulose sodium salt or guar gum 0.5 to 10% by mass, and
(f) silicon dioxide 0.1 to 5% by mass.

The gas generating composition of the invention may be formed into a molded article in a desired shape such as a single-perforated cylinder, a perforated (porous) cylinder or a pellet.

Such a molded article can be produced by an extrusion-molding method (a single-perforated cylinder and a perforated (porous) cylinder) comprising the steps of adding water or an organic solvent to the gas generating composition and extruding the mixture, or by a compression-molding method (the pellet shape) comprising the step of compressing the mixture using a pelletizer. The molded articles in the shapes of a single-perforated cylinder and a perforated (porous) cylinder may have either of a longitudinal through-holes or a hollow without penetrating.

The composition of the invention and a molded article obtained from the composition may be used for an inflator for an air bag for a driver side, an inflator for an air bag for a passenger side next to the driver, an inflator for a side air bag, an inflator for an inflatable curtain, an inflator for a knee bolster, an inflator for an inflatable seat belt, and inflator for a tubular system and an inflator for pretensioner, mounted in a variety of vehicles.

The inflators using the gas generating composition of the invention and a molded article obtained therefrom may be a pyrotechnic type in which a gas is supplied only from a gas generating agent or a hybrid type in which both of a compressed gas such as argon and a gas from the gas generating agent are supplied.

Further, the gas generating composition of the invention and a molded article obtained therefrom may be used as an igniting agent, so-called an enhancer (or a booster), for transmitting the energy of a detonator or a squib to a gas generating agent.

### EXAMPLES

Hereinafter, the invention will be described more in details according to Example, however, the invention is not limited to the Example.

### Example 1 and Comparative Example 1

The respective components shown in Table 1 in total 500 g and 737 g of water were loaded to a mixer and mixed. The mixture was extruded by an extruder, cut, and dried to obtain a gas generating composition in a shape of a single-perforated pellet which has the outer diameter of 4.25 mm, the inner diameter of 1.10 mm, and the length of 4.08 mm. 40.3 g of the gas generating composition was sealed air-tightly in a chamber having the inner diameter of 57 mm and the height of 32 mm to produce an inflator for test.

A discharged gas test of a 2800-liter tank was conducted using the inflator for test. The 2800-liter tank test was carried out by setting the inflator for test in a tank made of an iron and having a capacity of 2,800 liters, igniting the inflator, measuring the concentrations of NO, NO₂, CO and NH₃ by a detection tube in the tank after 3 minutes, 15 minutes and 30 minutes from the ignition and then determining the average values of the respective moments as the respective gas concentrations. The results are shown in Table 1.

TABLE 1

| | | Gas production amount | | | |
|---|---|---|---|---|---|
| | Gas generating composition | (ppm: based on the mass) | | | |
| | (% by mass) | NO | NO₂ | CO | NH₃ |
| Comparative | GN/BCN/Al(OH)₃/CMCNa | 6.8 | 0 | 70 | 12.7 |
| Example 1 | (36.98/48.02/10/5) | | | | |
| Example 1 | GN/BCN/Mg(OH)₂/CMCNa | 0.6 | 0 | 80 | 8.0 |
| | (36.98/48.02/10/5) | | | | |

GN indicates for nitric acid guanidine, BCN indicates for basic copper nitrate, and CMCNa indicates for carboxymethyl cellulose sodium salt. The average particle diameter of basic copper nitrate was 4.7 μm and the average particle diameter of magnesium hydroxide was 4.1 μm.

1. A gas generating composition comprising the following components (a), (b) and (c), and based on necessity, further comprising one, two, or three components selected from the following components (d), (e), and (f):
(a) an organic compound as fuel,
(b) an oxygen-containing oxidizing agent,
(c) magnesium hydroxide or a mixture of magnesium hydroxide and aluminum hydroxide,
(d) a binder,
(e) an additive selected from the group consisting of metal oxides and metal carbonates, and
(f) silicon dioxide having the specific surface area of 100 to 500 m²/g.

2. The gas generating composition as claimed in claim 1, comprises 10 to 60% by mass of the component (a), 10 to 85% by mass of the component (b), 0.1 to 20% by mass of the component (c), 20% by mass or less of the component (d), 20% by mass or less of the component (e) and 5% by mass or less of the component (f).

3. The gas generating composition as claimed in claim 1 or 2, wherein the organic compound (a) as fuel is at least one selected from the group consisting of tetrazole compounds, guanidizne compounds, triazine compounds, and nitroamine compounds.

4. The gas generating composition as claimed in claim 1 or 2, wherein (b) is at least one basic metal nitrate selected from the group consisting of basic copper nitrate, basic cobalt nitrate, basic zinc nitrate, basic manganese nitrate, basic iron nitrate, basic molybdenum nitrate, basic bismuth nitrate, and basic cerium nitrate.

5. The gas generating composition as claimed in claim 1, comprising, as the component (b), at least one oxidizing agent selected from the group consisting of (b-1) basic metal nitrates, nitrates and ammonium nitrates and (b-2) perchloric acid salts and chloric acid salts.

6. The gas generating composition as claimed in claim 5, wherein (b-2) the perchloric acid salts and chloric acid salts are at least one selected from the group consisting of ammonium perchlorate, potassium perchlorate, sodium perchlorate, potassium chlorate and sodium chlorate.

7. The gas generating composition as claimed in claim 1 or 2, wherein the binder as the component (d) is at least one selected from the group consisting of carboxymethyl cellulose, carboxymethyl cellulose sodium salt, carboxymethyl cellulose potassium salt, carboxymethyl cellulose ammonium salt, cellulose acetate, cellulose acetate butyrate, methyl cellulose, ethyl cellulose, hydroxyethyl cellulose, ethyl hydroxyethyl cellulose, hydroxypropyl cellulose, carboxymethyl ethyl cellulose, microcrystalline cellulose, polyacrylamide, amino compounds of polyacrylamide, polyacrylhydrazide, acrylamide-metal acrylate copolymer, polyacrylamide-poly(acrylic acid ester) copolymer, polyvinyl alcohol, acrylic rubber, guar gum, starch, and silicone.

8. The gas generating composition as claimed in claim 1 or 2, wherein the additive as component (e) is at least one selected from the group consisting of metal oxides comprising cupric oxide, iron oxide, zinc oxide, cobalt oxide, manganese oxide, molybdenum oxide, nickel oxide, bismuth oxide, silica or alumina; metal hydroxides comprising cobalt hydroxide or iron hydroxide; metal carbonates or basic metal carbonates comprising cobalt carbonate, calcium carbonate, basic zinc carbonate or basic copper carbonate; complex compounds of metal oxides or metal hydroxides comprising Japanese acid clay, kaolin, talc, bentonite, diatomaceous earth and hydrotalcite; metal acid salts comprising sodium silicate, mica molybdenic acid salt, cobalt molybdate or ammonium molybdate; silicone, molybdenum disulfide, calcium stearate, silicon nitride and silicon carbide.

9. A molded article of the gas generating composition in a shape of a single perforated cylinder, a perforated (porous) cylinder, or a pellet obtained from the gas generating composition as claimed in claim 1 or 2.

10. An inflator for an air bag using the gas generating composition as claimed in claim 1 or the molded article of the gas generating agent as claimed in claim 9.
